(19) United States
(12) Patent Application Publication
(10) Pub. No.: US 2023/0349506 A1
(43) Pub. Date: Nov. 2, 2023

(54) Tripod Leveling Head

(71) Applicant: Jeffrey Overall, Costa Mesa, CA (US)

(72) Inventor: Tyler Wilson, Huntington Beach, CA (US)

(73) Assignee: Polar Pro Filters, Inc., Costa Mesa, CA (US)

(21) Appl. No.: 17/734,787

(22) Filed: May 2, 2022

(51) Int. Cl. F16M 11/14; F16M 11/32; G03B 17/56

(52) U.S. Cl. CPC F16M 11/14; F16M 11/32; G03B 17/561

(57) ABSTRACT

A tripod leveling head with an extending handle as locking means. An articulating half ball may move independent of a stationary handle. This enables less restricted movement of the tripod legs in any leveling head orientation.

### FIELD OF INVENTION

The invention relates to camera mounts and stabilizers. Specifically, it relates to tripod heads.

### BACKGROUND

Tripod heads allow the adjustable attachment of cameras and other devices to a tripod or other mounting apparatus. Many tripod heads, such as ball heads, half ball levelers, pan heads, geared heads and gimbal heads—enable one or multiple degrees of freedom to adjust a coupled device. Half ball levelers enable such movement. Traditionally, a knob or handle extends downward from the half ball. The handle is used to control the tilt orientation of the half ball, and may enable a user to lock the half ball in specific orientations. This configuration required the handle be oriented at different angles, relative to the tripod legs, to achieve the corresponding half ball head tilt orientation. Certain tilt orientations cause the handle outward, forcing or restricting the movement of a leg. Additionally, it may prevent maintenance of certain tilt orientations while a tripod is retracted, as it may be during transportation.

### SUMMARY

The present invention provides a leveling ball head with a half ball capable of movement independent of and relative to the handle. This enables the tripod head to be manipulated while the knob remains stationary, allowing the tripod legs to be moved through their entire range of motion irrespective of the position of the tripod legs.

Multiple tripod legs may operatively couple with a bowl. An articulating half ball is disposed within or adjacent to the bowl. A bottom surface of the articulating half ball may be spherical, corresponding to the interfacing bowl surface. A top surface of the articulating half ball may couple with or comprise a mounting system capable of coupling a camera or other auxiliary device.

An internal half ball may be disposed within the articulating half ball. A handle may extend downward from the articulating half ball, passing through the articulating half ball and the bowl, into a leg cavity. The handle may enable adjustment of the internal half ball into a tilt position or a locked position. In the tilt position, the articulating half ball may be moved relative to the bowl and handle, into a plurality of tilt orientations. In a locked position, the internal half ball engages the articulating half ball, sandwiching it between the internal half ball and bowl, thereby locking it in place against a predetermined amount of force.

The handle may be operatively coupled with the bowl where it passes through the bowl. The handle remains aligned, along it's length, with a tilt axis, relative to which the articulating ball head is oriented. This handle alignment enables the tripod legs to be retracted and moved relative to the leg cavity.

### BRIEF DESCRIPTION OF THE DRAWINGS

FIG. 1A depicts a tripod in a closed position with legs retracted.

FIG. 1B depicts a tripod in an open position with the legs retracted.

FIG. 1C depicts a tripod in an open position with a second segment and third segment extended.

FIG. 2 is a front view of a tripod leg, a second segment and third segment and aspects of the first segment exploded.

FIG. 3A is a front view of an isolated locking system in an unlocked position.

FIG. 3B is a left side view of an isolated locking system in an unlocked position.

FIG. 3C is a front view of an isolated locking system in a locked position.

FIG. 3D is a left side view of an isolated locking system in a locked position.

FIG. 4A is a front view of a leg fully retracted and in an unlocked position.

FIG. 4B is a left side sectional view of a leg fully retracted, taken from FIG. 4A.

FIG. 4C is a front view of a leg fully retracted and in an locked position.

FIG. 4D is a left side sectional view of a leg fully retracted, taken from FIG. 4C.

FIG. 5 is a bottom left perspective view of locking system components and a leg rotation system.

FIG. 6A is a top right perspective view of an isolated switch and an isolated riser block FIG. 6B is a back view of an isolated switch and an isolated riser block.

FIG. 7 is a perspective view of an isolated tripod head.

FIG. 8 is a perspective view of an isolated tripod head exploded.

FIG. 9A is a planar view of an isolated tripod head.

FIG. 9B is a sectional view of the tripod head, taken from FIG. 9A.

FIG. 9C is a planar view of an isolated tripod head with an articulating half ball tilted.

FIG. 9D is a sectional view of the tripod head, taken from FIG. 9C.

### DRAWING NUMERALS

10 closed position
20 open position
50 slide position
60 lock position
100 Mounting system
101 Tripod head
110 Quick release attachment
120 Tilt core
130 Tilt drag knob
140 Drag ring
200 Bowl
250 Handle
252 Internal knob
254 Locking knob
270 Articulating half ball
272 Half ball aperture
276 Internal half ball
280 Anchor
290 Head screw
298 Ball cap
300 Tripod head handle
350 Dial
400 Angle selector
410 Switch
412 Riser lock
413 Beveled switch surface
414 Switch locked surface
415 Switch unlocked surface
416 Riser lock locked surface
417 Riser lock unlocked surface
418 Riser lock beveled surface
420 Angle selector button
422 Angle selector pin
424 Pin spring
428 Angle selector ratchet
430 Angle selector pivot
500 Leg
510 Leg cavity
520 First segment
522 First segment tube
524 Rod
525 Rod biasing spring
526 Biasing element
528 Tube lower
530 Angled bushing
540 Second segment
542 Second segment tube
544 Second segment tube top
558 Bottom latch
560 Third segment
652 Third segment tube
564 Third segment tube top
590 Foot

### DETAILED DESCRIPTION OF THE DRAWINGS

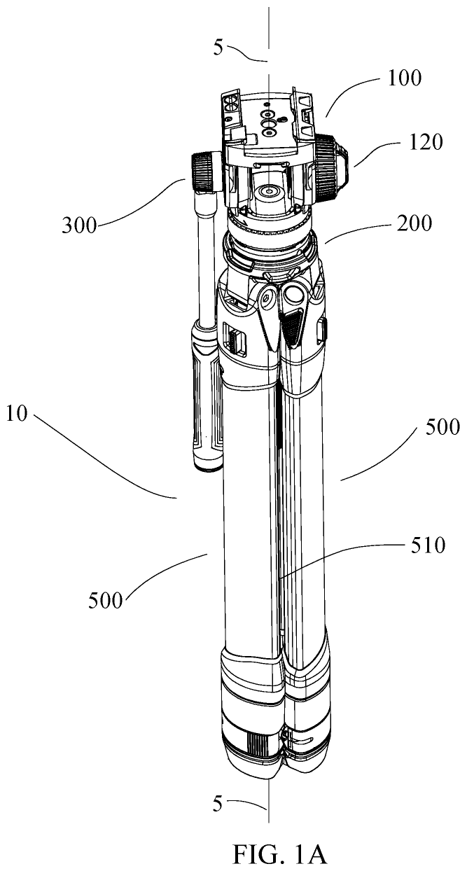

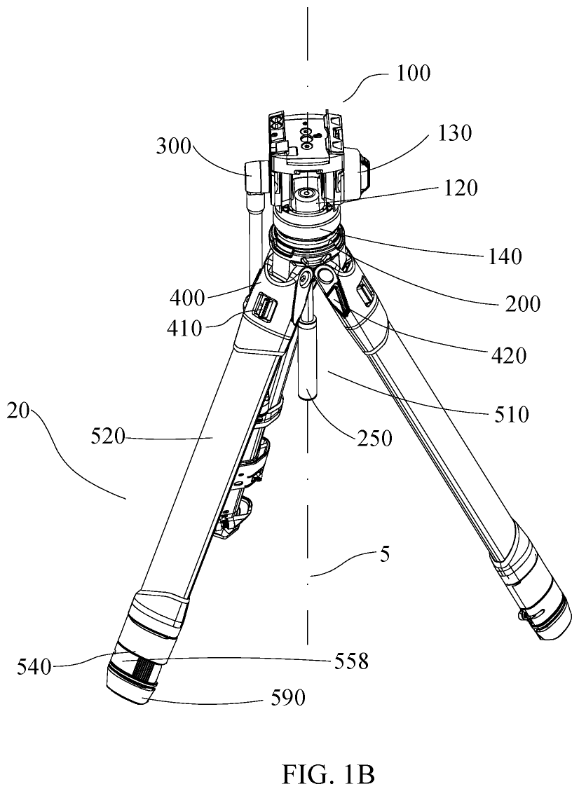

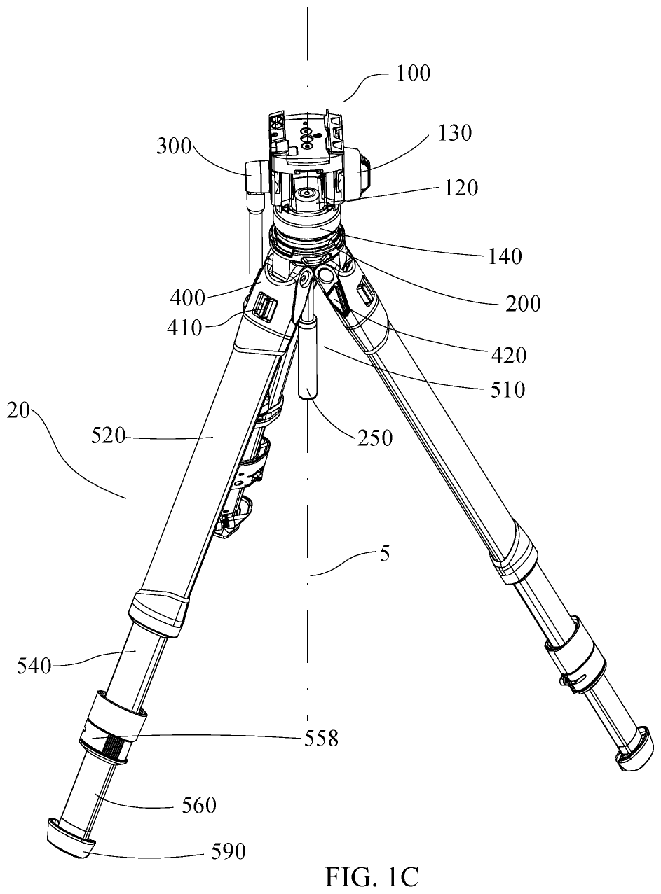

All three legs 500 may couple with a bowl 200. An articulating half ball 270 may couple a tripod head 100. The tripod head 100 may comprise a mounting system 101 as means of coupling a camera or other auxiliary device. In a closed position 10 (see FIG. 1) the legs 500 may extend roughly parallel to each other. In a closed position 10, each leg may abut the other two legs along a lengthwise edge, or there may be a small, i.e. 5-2 cm, space between the legs in some embodiments.

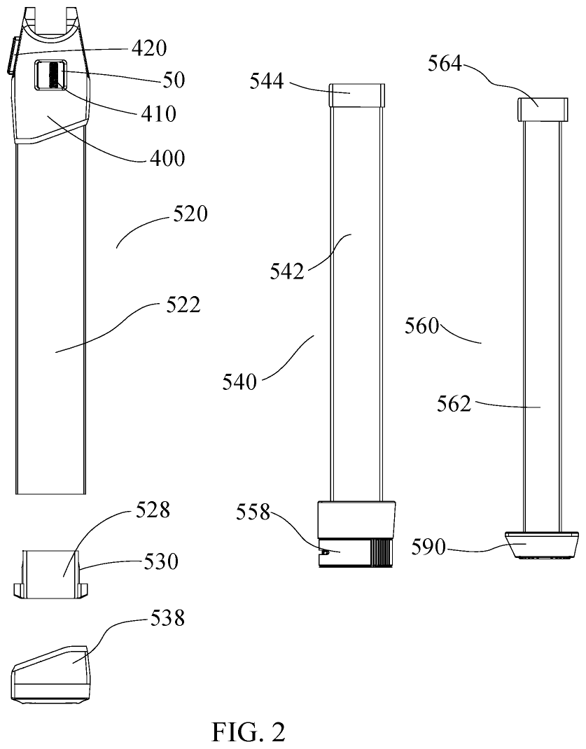

The legs 500 may pivotably couple with the bowl 200 via components of a leg rotation system. An angle selector ratchet 428 aspect of the bowl 200. An angle selector pin 422 may be inserted into the angle selector ratchet 428, enabling the leg to rotate into an open position 20 (see FIG. 2). A pin spring 424 may urge the angle selector pin 422 into a closed position 10, in which the leg cannot be rotated relative to the bowl 200. Applying a predetermined amount of force to an angle selector button 420 may urge the angle selector pin 422 out of the closed position 10 and enable rotation of the leg 500 relative to the bowl 200. References to “movement” or “rotation” of a first component “relative to” a second component means the first component can be moved while the second component remains stationary. When the force is removed from the angle selector button 420 the angle selector pin 422 may be urged back into the locked position, securing the leg 500 in the closed 10 or an open 20 position.

The legs 500 may be configured to create an intervening leg cavity 510.

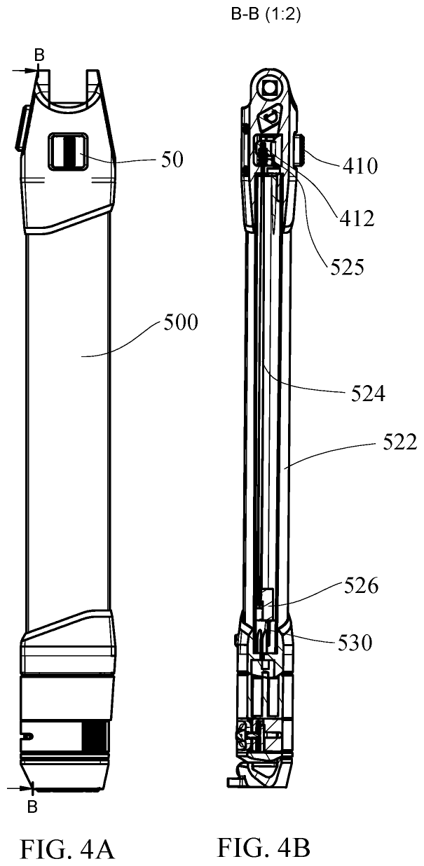

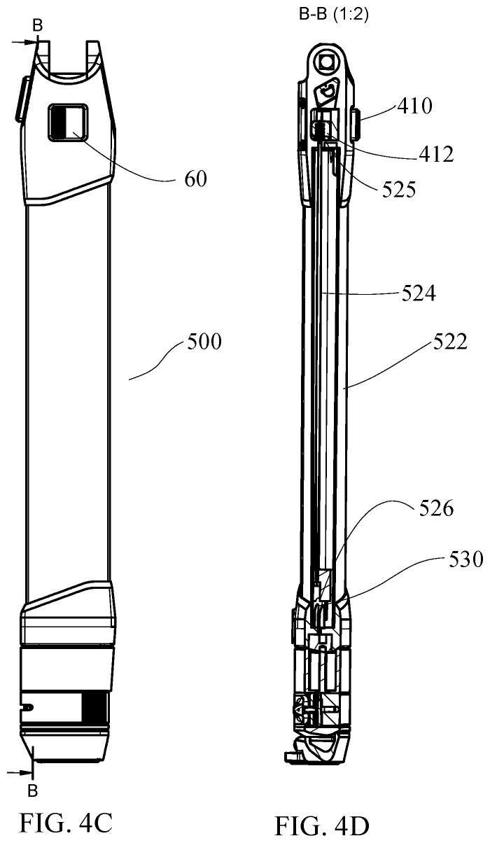

Each leg may be comprised of a first segment 520, second segment 540, and third segment 560. The second segment 540 may operatively couple with the first segment 520. “Operatively couple” means connection of the components with the ability to at least one component to move relative to another. The third segment 560 may operatively couple with the second segment 540. The second 540 and third segment 560 may extend from and retract up into the adjacent segment (520, 540; see FIGS. 16-C). A second segment tube top 544 may prevent the second segment from dislodging from the first segment 520 (see FIG. 4). A third segment tube top 564 may prevent the third segment 560 from dislodging from the second segment 540.

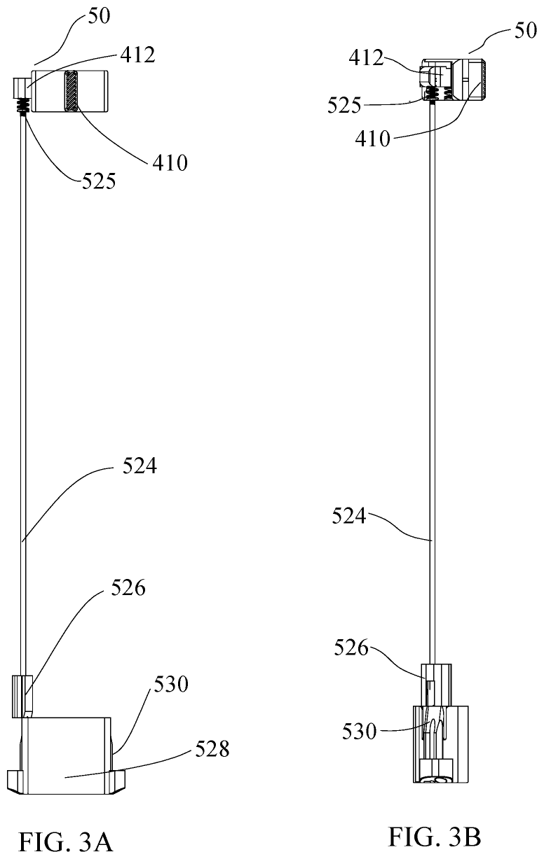

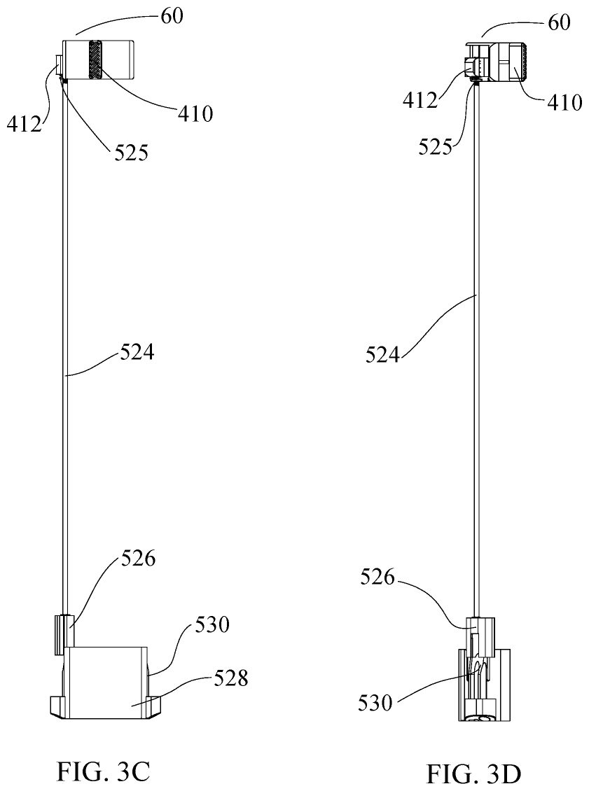

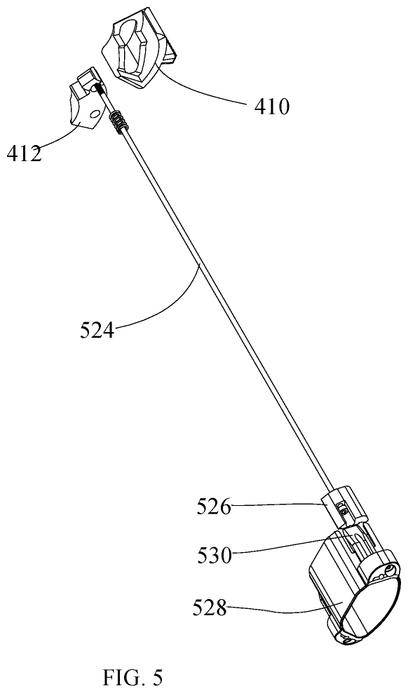

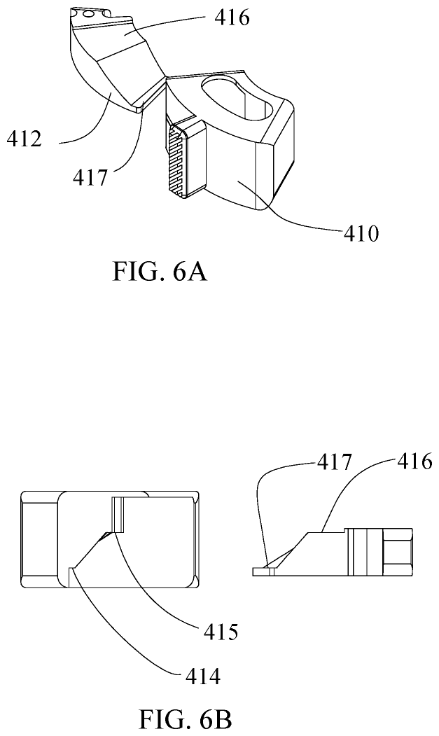

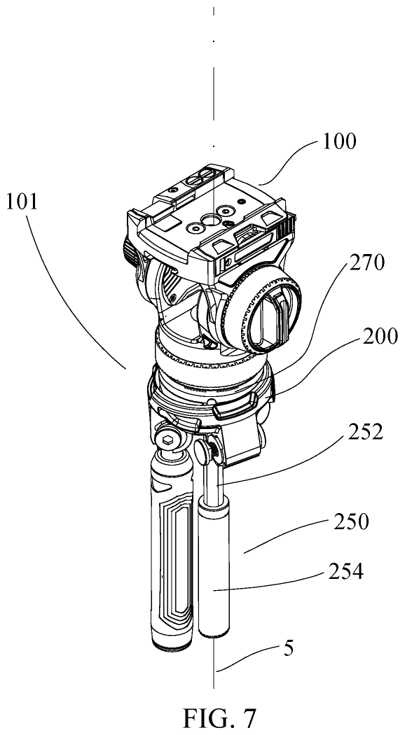

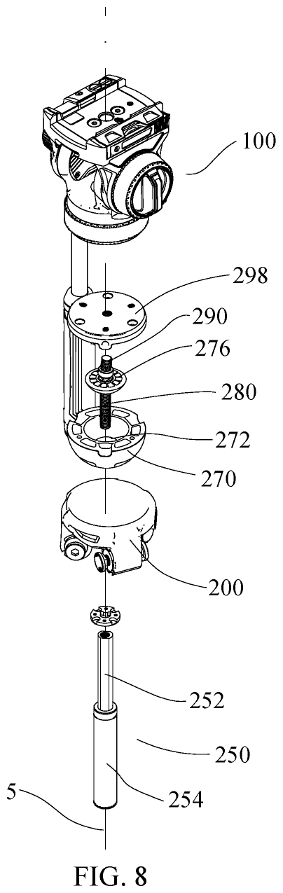

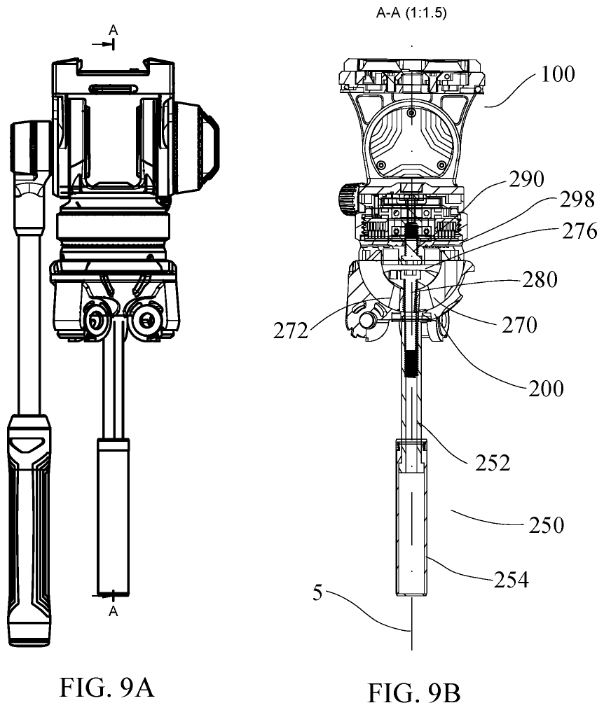

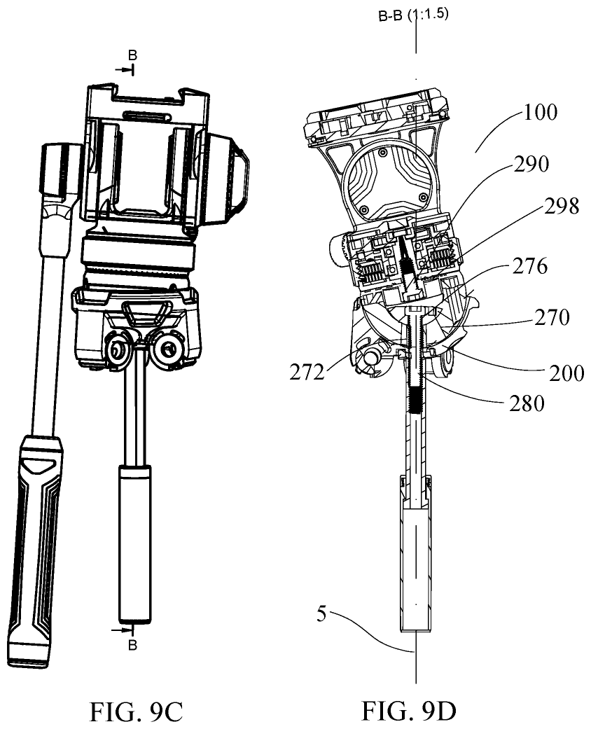

The first segment 520 may house locking system components. A rod 524 may be housed within the first leg segment 520, between the first segment tube 522 and second segment tube 542 (see FIGS. 4B and 5B). At a top end, the rod 524 may couple with a riser lock 412, and a biasing element 526 at a bottom end (see FIGS. 3A-D). A rod biasing spring 525 may urge the riser lock 412 up into an unlocked position 50. The rod biasing spring 525 may be disposed between the riser lock 412 and another surface relative to which the riser lock 412 moves. The riser lock 412 may abut or engage a switch 410. The switch 410 is accessible through an opening in the angle selector 400. The switch 410 may be manually moved out of the unlocked position into a locked position 60 (see FIGS. 3A-3B). In the exemplary embodiment, the switch 410 is moved laterally to adjust the switch 410—and locking system as a whole—from a locked 60 to an unlocked position 50. Interfacing surfaces of the riser lock 412 and switch 413 may be beveled so that transverse movement (rotation) of the switch left may force the riser lock 412 down, towards tube lower 528 aspect of the first segment 520 (see FIGS. 6A-B). The switch 410 may comprise a locked 414 and an unlocked surface 415, with an intervening beveled switch surface 413. The riser lock 412 may comprise corresponding locked 416, unlocked 417, and beveled 418 surface(s). In an unlocked position 50 the unlocked surfaces (414, 417) may abut, making it impossible to move out of the unlocked position without moving the switch 410 laterally. Movement of the switch 410 from the unlocked position 50 may cause engagement of the beveled surfaces (413, 418). The riser lock 412 is forced downward, until the locking surfaces (415, 416) abut and secure the locking system into a locked position 60.

The switch 410 and riser lock 412 may be comprised of aluminum or other metal or rigid material. The rod 524 may be comprised of steel and the biasing device 526 made of aluminum. The tube lower 528 and it's angled bushing aspect 530 may be comprised of a polyoxymethylene, another thermoplastic or another material enabling the requisite pliability.

The switch 410 may be rotated into a lock position 60. In a lock position 60 the riser lock and rod are forced against an angled bushing 530 aspect of the tube lower. The tube lower 528 sleeves the second segment tube 542, allowing it to pass through when the switch 410 is in a slide position 50. In a locked position 60, the rod forces the biasing element 526 down into the angled bushing 530. The interfacing surfaces of the biasing element 526 and angled bushing 530 may be beveled so that downward movement of the biasing element forces the angled bushing inward toward the second segment tube 542. In a locked position 50, the angled bushing 530 engages the second segment tube 542, locking it in position.

The third segment 560 may extend from the second segment 540. The second segment 540 may contain locking means enable the third segment 560 to be locked relative to it. A bottom latch 558 may serve as the locking means.

An articulating half ball 270 may be disposed between the bowl 200 and the tripod head 100. The articulating half ball 270 may be hemispherical and bowl shaped, with a recess in which an internal half ball 276 may be disposed. An anchor 280 couples with the internal ball and extends downward, through a half ball aperture 272 in the articulating half ball 270 and through an opening in the bowl 200. The anchor 280 connects with an internal knob 252 aspect of a locking knob 254.

A ball cap 298 aspect of the articulating half ball 270 may couple with the tripod head 100. A head screw 290 may couple the tripod head 100 and ball cap 298. The articulating half ball 270 is capable of movement relative to a tilt axis 5. The half ball aperture 272 may be configured to enable a certain tilt range which is limited by the articulating half ball 270 contact with the intervening anchor 280. The ball cap 298 and the tripod head 100 tilt with the articulating half ball 270, moving independently of the bowl 200, internal ball 276 and anchor 280. The ball cap 298 may be an integral aspect of the articulating half ball 270, or a modular component coupled the articulating half ball 270 via screws or other means. The ball cap 298 may be made of aluminum, another metal or thermoplastic. The internal ball 276 and articulating half ball 270 may be comprised of polyoxymethylene or other thermoplastic. The bowl 200 may be comprised of aluminum. The internal knob 252 may be comprised of steel or other metal or thermoplastic. The locking knob 254 may be comprised of aluminum or other metal or thermoplastic.

The handle 250 may enable adjustment of the internal ball 276 to a plurality of tilt orientations relative to the tilt axis 5. In the tilt position, the internal ball 276 is disengaged from the articulating half ball 270, enabling the articulating half ball 270 to move relative to the tilt axis 5, as discussed above. Rotation of the locking knob 254 aspect of the handle 250 around the tilt axis 5, may move the anchor 280, and in turn the internal ball 276 downwards into engagement with the articulating half ball 270. When a predetermined amount of pressure is exerted on the articulating half ball 270, it is locked between the internal ball 276 and bowl 200, thereby establishing the stable position. Rotation of the handle 250 in the opposite direction may move the internal ball 276 in the opposite direction, into a tilt position.

A handle 250 may extend into the leg cavity 510. Because the handle 250 remains stationary along the tilt axis 5, the legs may be oriented into the closed 10 position around it. Any tilt orientation may be maintained, irrespective of leg 500 orientation.

The foregoing discussion discloses and describes merely exemplary methods and embodiments. As will be understood by those familiar with the art, the disclosed subject matter may be embodied in other specific forms without departing from the essence or characteristics thereof. Accordingly, the foregoing disclosure is intended to be illustrative, but not limiting, of the scope of the invention, which is set forth in the claims.

I claim:

1. A leveling ball head, comprising:
a. a bowl housing an articulating half ball;
b. the articulating half ball comprising a half ball aperture;
c. a handle comprising an anchor;
d. an internal half ball coupling with a handle, the anchor extending through the half ball aperture and the bowl;
e. the articulating half ball being capable of movement relative to a tilt axis and the handle when the internal half ball is oriented in a tilt position;
f. the handle comprising locking means, enabling the user to adjust the internal half ball into a stable position, wherein the internal half ball engages the articulating half ball and locks it stationary relative to the tilt axis, against a predetermined amount of force.

2. A leveling ball head, comprising:
b. a bowl, the bowl housing an articulating half ball and internal half ball;
c. a handle aligning with a tilt axis, both the handle and tilt axis extending into a leg cavity;
d. the handle comprising an anchor;
e. the anchor coupling with the internal half ball;
f. the anchor being capable of a stable position, in which the internal half ball engages the articulating half ball and prevents movement of the internal half ball relative to the tilt axis, against a predetermined amount of force;
g. the anchor being capable of a tilt position, internal half ball is positioned so that the articulating half ball is capable of movement around the tilt axis;
h. the anchor remaining aligned with the tilt axis in the stable position and the tilt position.
